(19) United States
(12) Patent Application Publication
(10) Pub. No.: US 2021/0284221 A1
(43) Pub. Date: Sep. 16, 2021

(54) Motorized Cargo Cart

(71) Applicants: Cesar Perez, Greer, SC (US); Cheney Robinson, Rock Hill, SC (US)

(72) Inventors: Cesar Perez, Greer, SC (US); Cheney Robinson, Rock Hill, SC (US)

(21) Appl. No.: 16/817,092

(22) Filed: Mar. 12, 2020

(51) Int. Cl. B62B 5/00; B62B 3/02; B62B 3/12; B62B 5/04

(52) U.S. Cl. CPC B62B 5/0036; B62B 3/022; B62B 5/0069; B62B 2301/04; B62B 5/04; B62B 2205/10; B62B 2206/02; B62B 3/12

(57) ABSTRACT

A collapsible, motorized cargo cart includes an electric motor and a foldable frame that folds down flat for storage and transport. The frame member includes upper and lower frame portions in pivoting relation, and they can be positioned and locked at any desired angle with respect to each other. The lower frame member includes an extension that may be extended or retracted, as desired. Handlebars are provided on the upper frame member, and a throttle controls the speed of the cart, which is capable of transporting at least 300 pounds over rough terrain. Two large wheels are positioned on either side of the cart, and a removable caster wheel may be attached to a front portion of the frame. An electric motor and rechargeable battery are disposed on an underside of the frame's lower portion, and include a drive assembly to power the side wheels.

### BACKGROUND OF THE INVENTION

The present invention is generally directed to a motorized cart used to transport cargo, particularly over rough terrain. More specifically, the present invention includes a collapsible, motorized cart that can carry a substantial load, such as a game animal, over off-road trails, paths, or the like.

Motorized carts are used in many different types of applications, and are particularly useful for transporting heavy objects that would be difficult for a user to physically carry over medium to long distances. Some common uses for such carts include transporting beach accessories (towels, coolers, umbrellas, etc.) to the beach, transporting heavy items around a warehouse, hauling hunting gear into hunting grounds, and then hauling heavy game animals out of the woods or wilderness, and even include yard work applications for transporting tools, plants and refuse. Many different types of carts have been developed for these and other purposes, and the following documents provide examples of these efforts. The documents listed below are hereby incorporated by reference herein, in their entireties:

### U.S. Patent Publication Number 2016/0039445 Motorized Cart

A cart suitable for transporting game that includes a shield, an axle, an electric motor, a battery, a first wheel, a second wheel, and a frame. The axle is attached to the frame so that the axle can rotate around the longitudinal axis of the axle, the first wheel is spaced apart from the second wheel. The first and second wheels are attached to the axle. The electric motor is in mechanical communication with the axle. The electric motor is in electrical communication with the battery so that the electric motor causes the axle and wheels to rotate. The shield is attached to the frame at a position below the axle so that the cart is protected when traversing undeveloped and rough terrain where, for example, rocks, stumps or other such conditions may be encountered which could damage components of the cart such as the motor or axle.

U.S. Patent Publication Number 2008/0197608 Powered Utility Cart with Drivetrain Differential

A hunting cart designed to assist a hunter with transporting objects such as hunting equipment and large game. The cart includes a pair of side rails that are arcuate in shape and parallel with each other. Interposed the side rails are a plurality of cross support members, a handle and an end rail defining the frame of the cart. A drive assembly is present that is operably connected to an axle, which is rotatably mounted to two wheels. The drive assembly includes an electric motor, a power source and a chain.

### U.S. Patent Publication Number 2007/0194560 Foldable Cart

The invention provides a cart for transporting objects, such as game, that can be folded into a closed configuration for easy transportation and storage. In the open configuration, the cart is suitable for transporting heavy objects over difficult terrain. The cart has an angled frame such that it cradles the object retained thereon. The cart is designed such that an object can be easily loaded onto the cart. For example, the cart may be pivoted downward to minimize the distance that the object being loaded on the cart needs to be lifted, and the cart also has one or more rollers that allow the object to be slidably loaded and positioned on the cart. The cart may additionally have retaining straps to secure an object to the cart. Finally, the cart has forward wheels that allow the cart to be easily loaded into a vehicle.

### U.S. Patent Publication Number 2004/0084864 Motorized Field Cart

The current invention provides a motorized single wheel cart. The motorized cart is particularly suited for use in wilderness areas lacking modern roads. The motorized cart has a readily detachable motor and is capable of carrying several hundred pounds of cargo. The motorized cart will readily traverse streams, downed trees and rocks while carrying big game. Additionally, the motorized cart will be useful for search and rescue squads assisting injured hikers and backpackers.

U.S. Pat. No. 7,793,744 Cart Apparatus

A cart apparatus includes a frame for receiving game. The frame includes a pair of side supports and a plurality of lateral supports that are attached to and extend between the side supports. A netting material is attached to the frame and extends between the side supports. An axle is rotatably coupled to the frame. The axle extends between the side supports and has a pair of opposite ends. A pair of wheels is attached to the axle. Each of the wheels is positioned adjacent to one of the opposite ends. A motor is mounted to the frame. A drive shaft is mechanically coupled to the motor and to the axle. The motor rotates the wheels when the drive shaft is engaged.

U.S. Pat. No. 7,017,939 Versatile Portable Cart

A multi-purpose, collapsible portable cart, for use in camping, hunting and other outdoors activities carries medical rescue carts, canoes, small boats, game, or hauled cargo by hand. The portable cart can be converted to various uses and the portable cart can be folded down and transported within a backpack, hand carried bag, canoe or boat. It transports injured persons or cargo over long, rough terrain and it can broken down into a carrying position, by hand or by back. Its width can be varied to accommodate cargo of varying widths. Two or four wheeled versions can be assembled with axles and wheels. The cart has optional removable clamps for clamping a conventional transportable carrier, such as a stretcher or stokes-type rescue carrier bed, thereto. The objects being carried can be held by clamps, by fasteners, or through the use of insertions with longitudinally extending channels. An optional pivotable kickstand and/or tie rods can stabilize the cart in a position of rest. It is collapsible, so that it can be disassembled and carried, and then reassembled at another destination along a wilderness journey.

U.S. Pat. No. 6,793,236 Motorized Game Cart

A motorized game cart having a frame with wheels mounted to an axle. A portable power drill is mounted to the frame with the chuck of the power drill mounted to a gear box connected to the axle for rotating the axle when the power drill is operated. A drive sprocket is fixedly mounted to a ball bearing assembly mounted for free rotation about the axle. The ball bearing assembly further having a female portion of a socket coupler. A male portion of the socket coupler is secured to the axle to rotate with the axle but is movable longitudinally along the axle. A control rod is provided for moving the male portion into coupling relation with the female portion. A follower sprocket is mounted on a differential mounted to the axle between the two wheels. An endless chain connects the drive sprocket with the follower sprocket.

U.S. Pat. No. 6,173,799 Motor-Assisted Single-Wheel Cart

A motor-assisted single-wheel cart is provided with a motor for generating an assisting power in response to an operation force when operating an operation handle by a human hand, and a power transmission mechanism for transmitting an output of the motor to an axle. The motor is arranged rearwardly upwardly of the axle so as to be positioned within a space surrounded by an upper horizontal member and a lower member positioned below the upper horizontal member constituting a vehicle body frame constituting the cart as viewing the vehicle body frame from a side surface thereof. The power transmission mechanism has a first speed reduction mechanism arranged near the motor, a second speed reduction mechanism arranged near the wheel and a transmission shaft for connecting them. The transmission shaft is inserted to the first and second speed reduction mechanisms so as to be capable of being drawn out.

U.S. Pat. No. 6,129,166 Electromotive Cart

A four-wheeled-electromotive cart includes a single motor and a direct axle driving mechanism for driving the axle of left and right front wheels by means of the motor. The single electric motor would cause no rotation speed difference between the left and right front wheels and hence constantly permits a smooth linear movement of the electromotive cart. The direct axle driving mechanism includes a relay shaft connected to the output shaft of the electric motor, a small-diameter bevel gear mounted on a lower end of the relay shaft, and a large-diameter bevel gear engaging with the small-diameter bevel gear. The front-wheel axle is spline-connected to the large-diameter bevel gear so as to be driven by the motor via the direct axle driving mechanism. Thus, the electromotive cart is allowed to smoothly start moving without sudden jolts or shocks caused by start of the motor rotation.

Other examples of wagons and carts include the following:
U.S. Pat. No. 9,908,570
U.S. Pat. No. 5,685,385
U.S. Pat. No. 3,007,536
U.S. Pat. No. 6,811,179
U.S. Pat. No. 5,564,605
U.S. Pat. No. 4,538,695
U.S. Pat. No. 8,746,377
U.S. Pat. No. 5,284,218
U.S. Patent Publication No. 2018/0215404
U.S. Patent Publication No. 2010/0044125
U.S. Patent Publication No. 2008/0315541

All of the above-referenced carts include disadvantages, and it is therefore an object of the present invention to provide a motorized cart that is collapsible for transport and storage, includes an expandable frame for larger loads, and is capable of carrying heavy objects over non-paved, rough terrain or surfaces. Additionally, it is an object of the present invention to provide a motorized cart that may be operated quietly, is easy to use, and is lightweight enough for a user to be able to pick it up and carry it in a collapsed or folded state without suffering undue stress. Other objects and advantages will become apparent via the description and discussion included herein.

### BRIEF DESCRIPTION OF THE DRAWINGS

These and other features, aspects, and advantages of the present invention will become better understood with regard to the following description, appended claims, and accompanying drawings where:

FIG. 1 is a perspective view of one embodiment of a motorized cargo cart in accordance with the present invention, wherein the cart includes a foldable frame member having an upper portion and a lower portion, a pair of side/rear wheels on an underside of the lower portion of the frame, an electric motor with a drive chain for driving the side/rear wheels, a caster wheel on a front portion of the lower portion of the frame, an extension member positioned on a front of the lower portion of the frame, and handlebars with a throttle positioned at the top of the upper portion of the frame;

FIG. 2 is a side view of the embodiment of the motorized cargo cart shown in FIG. 1, further showing the motor having a sprocket and chain for rotating a gear that is attached to the axle between the side/rear wheels;

FIG. 3 is a side view of one embodiment of the motorized cargo cart, wherein the frame is shown in a folded down, collapsed position so that the upper portion of the frame member lies flat against the lower portion thereof; and

FIG. 4 is a rear view of one embodiment of the motorized cargo cart, wherein the frame is shown in a folded down, collapsed position, and further showing the motor, drive train and axle assembly attached on an underside of the lower portion of the frame member.

### DETAILED DESCRIPTION OF THE INVENTION

Overview

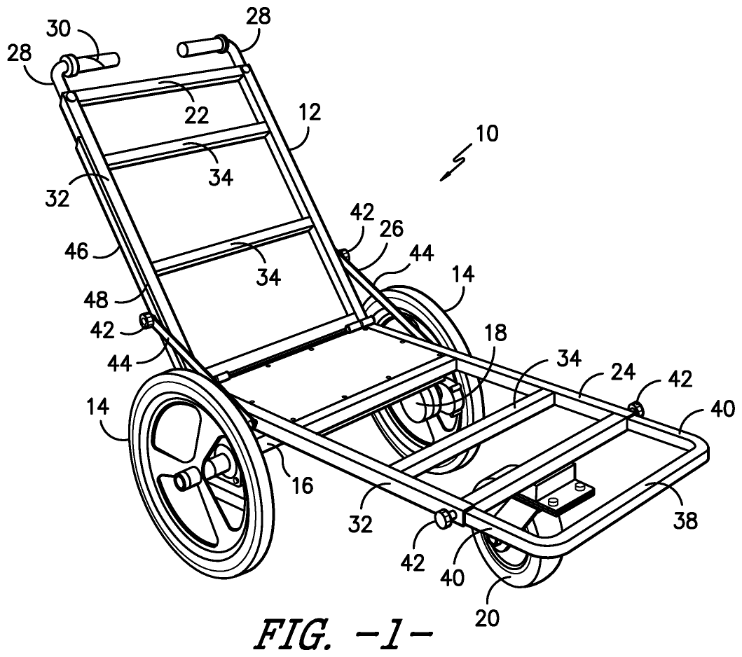

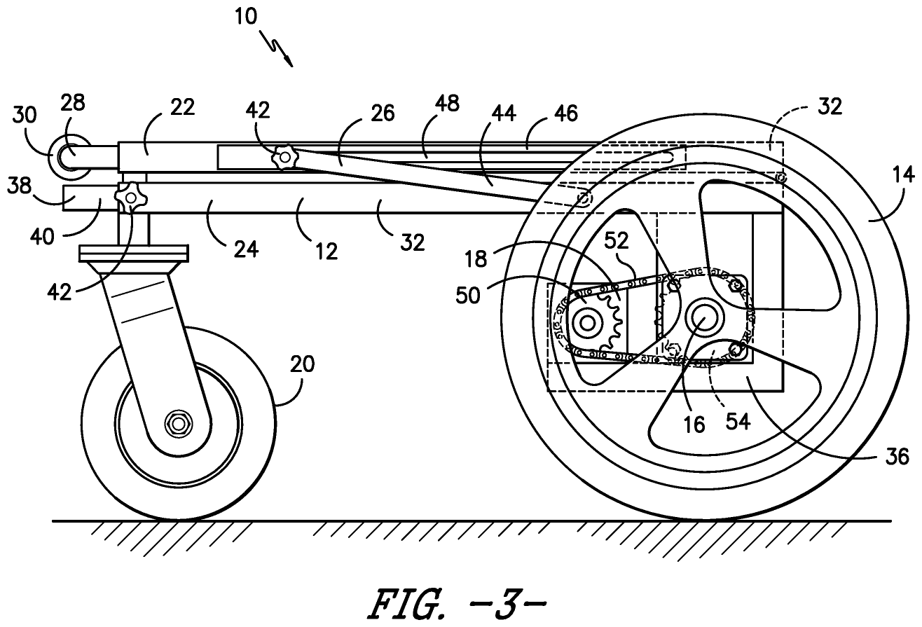

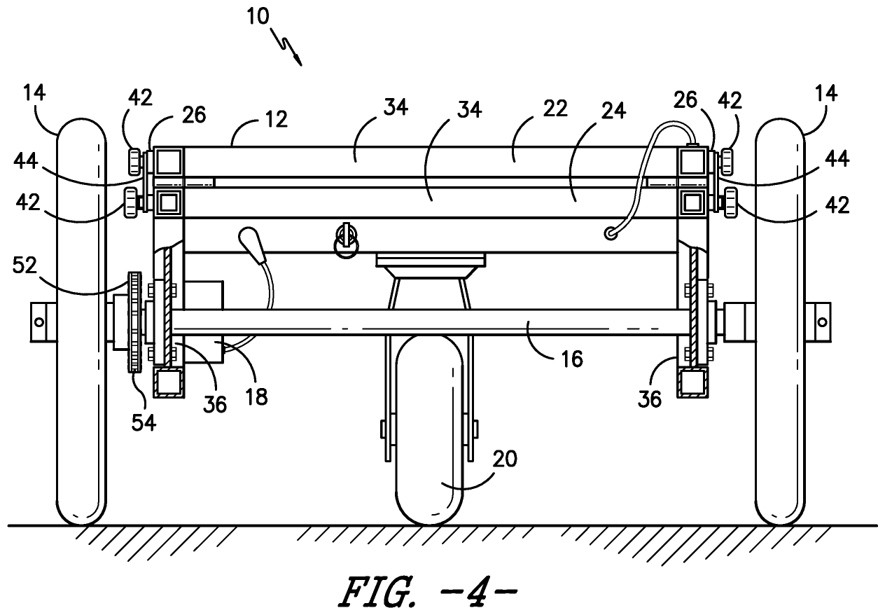

The present invention includes, in a first embodiment as shown in FIGS. 1-4, a motorized cart 10 that includes a folding frame 12, a pair of side/rear wheels 14 connected to one another by an axle 16, a motor 18 that is operatively connected to the side wheels 14, and a front caster wheel 20 that is preferably removable from the frame 12. The folding frame member 12 includes an upper portion 22 and a lower portion 24, which are connected in a pivoting relationship (preferably by a hinge) so that the upper portion 22 can be folded down to lay generally flatly against the lower portion 24 of the frame member, as shown in FIGS. 3-4. An adjustable sliding lock mechanism 26 allows a user to unfold the frame member 12 and position the upper portion 22 of the frame 12 at any desired angle with respect to the lower frame member 24, and to then lock the frame members 22, 24 into that desired position, as shown in FIG. 1. In one preferred embodiment, a pair of handlebars 28 are positioned at the top of the upper portion 22 of the frame 12, and a throttle 30 is positioned on one handlebar 28 for controlling the speed (and possibly the direction of motion, either forward, reverse or neutral) of the cart 10. In another embodiment, the system may be powered in the forward direction only, so that the wheels 14 may move freely in a reverse direction when power is off, or when power is not being applied by actuating the throttle 30.

To use the cart 10, a user simply unfolds the collapsible frame 12 into the desired position, locks the frame 12 in place to maintain that position during use, and attaches the front caster wheel 20 to the front of the lower portion 24 of the frame member 12. It should be understood that the caster wheel 20 may also be permanently attached to the lower portion of the frame member. The user then places and secures a load (for example, a game animal such as a deer, boar, a quartered moose, or the like) onto the cart 10, and stands behind the cart 10, grasping the handles on the handlebars 28. The user controls the speed of the cart by rotating the throttle 30 (in a similar manner to a throttle on a motorcycle or the like). In one embodiment, the throttle 30 may be used to shift the motor 18 into forward gear, rearward gear, or neutral. It is contemplated that the gears may be shifted through other means, such as a separate switch or lever, as an alternative embodiment.

The Collapsible Frame

In a preferred embodiment, the frame member 12 includes an upper portion 22 and a lower portion 24 that are hinged and operate in a pivotal relationship, and a sliding lock mechanism 26 allows infinite adjustment with respect to the angle between the upper 22 and lower portions 24. Both the upper portion 22 and the lower portion 24 include side support members 32 and cross support members 34, and the frame member 12 is preferably made from aluminum, although any suitable material may be used. The lower portion 24 of the frame 12 carries the motor 18, axle supports with bearing assemblies 36, a battery and a removable caster wheel 20 that is centrally disposed on a front end thereof. Optionally, one or more panels may be placed between the cross supports 34 and the side supports 32, particularly on the lower portion 24 of the frame 12 to provide a flat cargo surface, and it is contemplated that the panels may be removable, as desired.

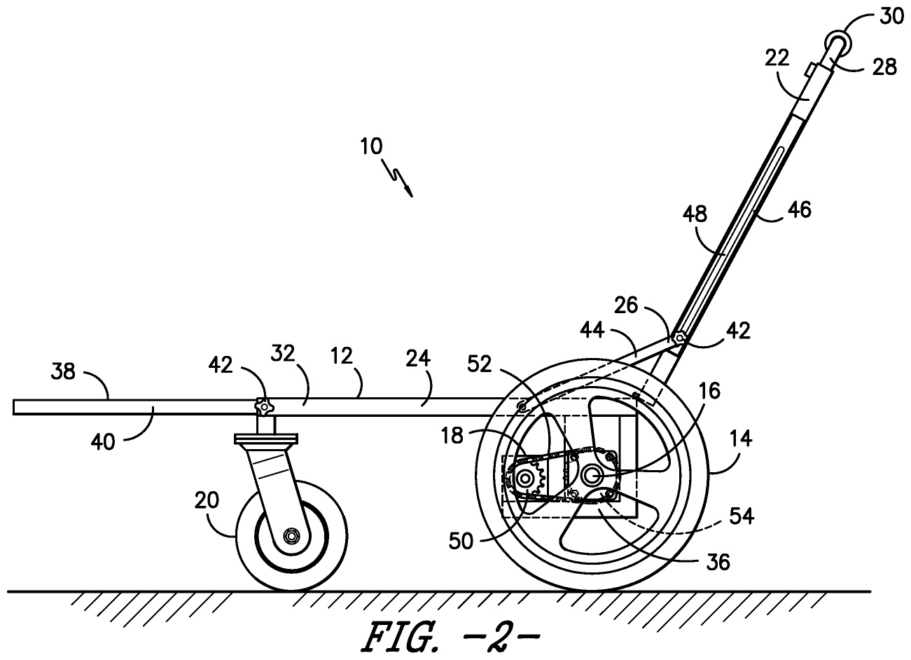

The lower portion 24 of the frame 12 may also include an extension member 38 that has a cross support member 34 and a pair of arms 40 that extend telescopically into side support members 32 of the lower portion 24 of the frame 12, as shown. A screw locking mechanism 42 is disposed on the outside of the side support members 32, and may comprise a threaded shaft at one end and a knob on the other end, which is used to tighten and secure the extension member 38 in any desired position. The extension member 38 may be extended outwardly (forwardly) from the lower portion 24 of the frame 12, and may be temporarily secured by screwing the locking mechanism 42 inwardly through a threaded hole in the side support members 32 so that the shaft of the screw locking mechanism 42 is pressed tightly against the arms 40 of the extension member 38, as shown in FIGS. 1-2. It should be understood that other suitable types of locking mechanisms may be used to temporarily secure the extension member 38 to the lower portion 24 of the frame 12, in alternate embodiments.

The sliding lock mechanism 26 allows the angle of the frame's upper portion 22 and lower portion 24 to be fixed in any desired position. The sliding lock mechanism 26 includes an angular support 44 that is attached on one end thereof to the side support members 32, preferably on both sides of the cart 10, in pivoting relation. The other end of the angular support 44 is attached to a track support member 46 that includes a track or slot 48. A threaded sliding member is disposed within the track member so that it may slide along the track or slot 48. A screw locking member 42 may be attached to the threaded sliding member through a hole disposed at an upper end of the angular support 44, so that the screw locking member 42 may be tightened down to temporarily lock the angular position of the frame's upper portion 22 with respect to the frame's lower portion 24. The upper portion 22 of the frame 12 may be folded down flat against the lower portion for storage and transport, as shown in FIGS. 3-4.

The rear/side wheels 14 may also be removable, and may include a quick-release mechanism to facilitate easy removal and reattachment of the wheels, as desired. Such quick-release mechanisms are well-known in the art, and any suitable quick-release mechanism may be used to attach the rear/side wheels to the axle.

Motor and Drive Assembly

The motor 18 is preferably a rechargeable, DC electric motor that is mounted on the underside of the lower portion 24 of the frame 12. The motor 18 is operatively connected to a throttle 30 on the handlebars 28, and the throttle 30 is used to control the speed, and optionally, to shift gears between forward, reverse and neutral. The motor 18 includes a rotating sprocket 50, in one embodiment, and the sprocket rotates a chain 52 that engages a gear 54 attached to the axle 16. It should be understood that other drive mechanisms may be used, such as belts or direct drive systems. The motor 18 is preferably powered by a rechargeable battery that is also mounted beneath the lower portion 24 of the frame 12. In a preferred embodiment, the motor 18 and battery may be formed as a modular unit, so that the modular unit may be removed and replaced by a new unit in modular fashion. The motor 18 and battery are preferably encased in a waterproof or water resistant housing. A power cord may be operatively connected to the battery and plugged into a standard 110 volt electrical receptacle for recharging, and in a preferred embodiment, the cord is removable from the cart when not in use. In a preferred embodiment, an ignition unit and key (or key fob, or the like) may be included, so that it is necessary to place the key into the ignition unit in order to operate the motorized cart.

Additionally, in a preferred embodiment, the drive assembly, including the gears, chain (or belt), and sprocket may be encased in a housing to prevent water, dirt, and foreign objects from interfering with the drive operation of the cart.

Performance

The following performance specifications are described for a preferred embodiment of the motorized cargo cart, but it should be understood that other performance parameters may be used without departing from the spirit or scope of the present invention. The motorized cargo cart 10 is capable of transporting up to at least 300 pounds in a preferred embodiment, and the battery operation time should meet or exceed 2.5 hours. The cart is water resistant, and may be used even if the battery is dead, so that the wheels 14 turn freely when the motor is not powered on. The cart 10 is preferably lightweight with a maximum preferred weight of 40 pounds, so that a user can reasonably pick it up and carry it, if necessary. The motor 18 is capable of providing at least 75% of the force required to transport a 300 lb cargo up a 20 degree incline or hill, and is further capable of speeds of at least 3 miles per hour (average human walking speed). The larger side/rear wheels 14 preferably provide at least 6-8 inches of clearance, so that the cart 10 may traverse over small logs, rocks, roots and other obstacles typically found in rough terrain.

Optional Features

In some embodiments, other optional features may be included with the motorized cargo cart. A pair of backpack style shoulder straps may be removably attached to the cart in its folded configuration, so that a user may strap the cart to his or her back. Lights may be attached to the cart in any desirable configuration and powered either separately from the cart battery, or powered by the cart battery, including headlights, LED light strips, emergency flashing lights, or any other desired lighting. One or more solar panels may be operatively attached to the cart battery for recharging in the field, if necessary. Additionally, a transceiver or chip may be attached to the cart for allowing a user to remotely locate the cart, similarly to the “Find My Phone” feature on Apple iPhones. A battery life indicator may be operatively attached to the battery, in order to indicate how much power is remaining in the battery at any given time. Gear pouches may be attached to the frame in any desired position or configuration. Different sizes and types of wheels 14 may be used, as desired, for different types of terrain. For example, the wheels and tires may be wider for sandy areas such as beaches and deserts, and different treads may be similarly employed for smooth surfaces, muddy surfaces, wet surfaces, or the like. Other accessories may include gun holders, bow holders, fishing rod holders, or other types of tool holders, and each of these may be permanently or removably attached to the cart in any desired manner.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

1. A motorized cargo cart comprising:
a frame member, said frame member having an upper portion and a lower portion that are in a pivoting relationship with one another so that said upper portion and said lower portion of said frame member may be folded flat against one another for transport and storage;
a motor disposed on an underside of said lower portion of said frame member;
an axle attached to said underside of said lower portion of said frame member so that said axle may rotate;
said motor being operatively connected to said axle in order to rotate said axle; and
a pair of side wheels attached to said axle, wherein said wheels are disposed on opposed sides of said frame member.

2. The motorized cargo cart set forth in claim 1, further including an extension member attached to said lower portion of said frame in a telescopic manner, so that said extension member may be extended outwardly from said lower portion of said frame member.

3. The motorized cargo cart set forth in claim 2, further including a locking mechanism for temporarily securing said extension member in a desired position during use.

4. The motorized cargo cart set forth in claim 1, further including a pair of handlebars positioned at an upper end of said upper frame member.

5. The motorized cargo cart set forth in claim 4, further including a throttle positioned on one of said handlebars, wherein said throttle is operatively connected to said motor to control speed of said cart.

6. The motorized cargo cart set forth in claim 1, further including a drive assembly operatively connecting said motor to said axle, wherein said drive assembly is selected from the group of chains and belts.

7. The motorized cargo cart set forth in claim 1, further including a caster wheel disposed on an underside of said lower frame member.

8. The motorized cargo cart set forth in claim 7, wherein said caster wheel is removable from said lower frame member.

9. The motorized cargo cart set forth in claim 1, wherein said motor is an electric, direct current motor that is rechargeable.

10. The motorized cargo cart set forth in claim 1, further including a sliding lock mechanism for temporarily locking said upper portion of said frame member into any desired angular configuration with respect to said lower portion of said frame member.

11. The motorized cargo cart set forth in claim 10, wherein said sliding lock mechanism comprises an angular support member that is attached in pivoting relationship to said lower portion of said frame member, and is attached in sliding relationship to said upper portion of said frame member.

12. A motorized cargo cart comprising:
a frame member, said frame member having an upper portion and a lower portion that are in a pivoting relationship with one another so that said upper portion and said lower portion of said frame member may be folded flat against one another for transport and storage;
a motor carried by said frame member;
a pair of side wheels attached to said axle, wherein said wheels are disposed on opposed sides of said frame member, and wherein said motor is operatively connected to at least one of said side wheels; and
wherein said cart has a weight that is equal to or less than 40 pounds.

13. The motorized cargo cart set forth in claim 12, wherein said wheels are removable.

14. The motorized cargo cart set forth in claim 12, wherein said cart is capable of providing sufficient force and structural integrity for transporting loads of at least 300 pounds.

15. The motorized cargo cart set forth in claim 12, wherein said cart includes a ground clearance of at least 6 inches as measured between a ground surface and an underside of said lower frame member.

16. A motorized cargo cart comprising:
a frame member, said frame member having an upper portion and a lower portion that are in a pivoting relationship with one another so that said upper portion and said lower portion of said frame member may be folded flat against one another for transport and storage;
a pair of wheels disposed on opposed sides of said frame member
a motor carried by said frame member for rotating at least one of said wheels;
a pair of handlebars attached to said upper portion of said frame member, wherein a throttle is positioned on one of said handlebars; and
wherein said throttle is operatively connected to said motor to control speed of said cart.

17. The motorized cargo cart set forth in claim 16, further including an adjustable extension member attached to said lower portion of said frame member, so that said lower portion of said frame member may be enlarged to carry larger loads.

18. The motorized cargo cart set forth in claim 16, wherein said cart is capable of providing sufficient force and structural integrity for transporting loads of at least 300 pounds.

19. The motorized cargo cart set forth in claim 16, wherein said cart includes a ground clearance of at least 6 inches as measured between a ground surface and an underside of said lower frame member.

20. The motorized cargo cart set forth in claim 16, further including a caster wheel disposed on an underside of said lower frame member.
